(19) United States
(12) Patent Application Publication
(10) Pub. No.: US 2023/0121712 A1
(43) Pub. Date: Apr. 20, 2023

(54) String Alignment with Translocation Insensitivity

(71) Applicant: S&P Global Inc., New York, NY (US)

(72) Inventor: Tom Wentworth, Natick, MA (US)

(21) Appl. No.: 17/451,228

(22) Filed: Oct. 18, 2021

(51) Int. Cl. G06F 40/40

(52) U.S. Cl. CPC G06F 40/40

(57) ABSTRACT

A method, apparatus, system, and computer program code for determining string alignment with insensitivity to translocation. A computer system arranges a pair of strings in a similarity matrix. The computer system determines a match score for an optimal local alignment of whole-word sequences between the pair of strings. The computer system masks the whole-word sequences of the optimal local alignment to generate word-masked strings. Using the word-masked strings, the computer system repeats the arranging, determining, and masking steps a number of times to generate a number of match scores. The computer system combines the number of match scores into a combined score that represents similarities between the pair of strings, wherein the combined score is insensitive to translocation and word truncations. Based on the combined score, the computer system determines alignment between the pair of strings.

### BACKGROUND

### 1. Field

The disclosure relates generally to an improved computer system and, more specifically, to a method, apparatus, computer system, and computer program product for determining string alignment with insensitivity to translocation.

### 2. Description of the Related Art

The Harmonized System (HS) is a standardized numerical method of classifying traded products that serves as the foundation for the import and export classification systems around the world. The HS assigns specific six-digit codes for varying classifications and commodities. Individual countries can provide for further classification by appending additional codes to the six-digit HS code. Customs authorities use the HS to identify products when assessing duties and taxes and for gathering statistics.

Insights derived from customs records may provide great benefit to a wide range of businesses, individuals, governments, and the like. However, reliance on HS codes for purposes other than assessments may lead to inaccurate conclusions about content, value, volume, weight, container type, and the like of an international shipment. Rather than relying solely on HS codes, analysis of customs records may utilize the free-form phrase-like text content found in portions of these customs records. The text fields of the customs records often lack full sentences and may lack complete words that are used in typical natural language communication. For example, they may include fewer than ten words, fewer than five words, fewer than three words, or even contain as few as one or two abbreviations or acronyms that are not defined in non-technical dictionaries.

Attempts have been made to adapt natural language processing (NLP) to facilitate analysis and categorization of customs records. Generally, natural language processing has been applied to human language content, such as full sentences of prose or speech, rather than to non-natural language content, such as the terse, jargon-laden, multiple-language content that characterizes customs transaction records. However, in the context of customs records analysis, known natural language processing algorithms, including word-stemming, word-singularizing, syllable, and character sequence analysis, and/or similarity-matched word counting and the like, do not perform as well as desired.

### SUMMARY

According to one embodiment of the present invention, a method provides for determining string alignment with insensitivity to translocation. A computer system arranges a pair of strings in a similarity matrix. The computer system determines a match score for an optimal local alignment of whole-word sequences between the pair of strings. The computer system masks the whole-word sequences of the optimal local alignment to generate word-masked strings. Using the word-masked strings, the computer system repeats the arranging, determining, and masking steps a number of times to generate a number of match scores. The computer system combines the number of match scores into a combined score that represents similarities between the pair of strings, wherein the combined score is insensitive to translocation and word truncations. Based on the combined score, the computer system determines alignment between the pair of strings.

According to another embodiment of the present invention, a computer system comprises a hardware processor, and a string alignment engine indication with the hardware processor. The string alignment engine is configured: to arrange a pair of strings in a similarity matrix; to determine a match score for an optimal local alignment of whole-word sequences between the pair of strings; to mask the whole-word sequences of the optimal local alignment to generate word-masked strings; using the word-masked strings, to repeat the arranging, determining, and masking steps a number of times to generate a number of match scores; to combine the number of match scores into a combined score that represents similarities between the pair of strings, wherein the combined score is insensitive to translocation and word truncations; and to determine alignment between the pair of strings based on the combined score.

According to yet another embodiment of the present invention, a computer program product comprises a computer-readable storage media with program code stored on the computer-readable storage media for determining string alignment with insensitivity to translocation. The program code is executable by a computer system: to arrange a pair of strings in a similarity matrix; to determine a match score for an optimal local alignment of whole-word sequences between the pair of strings; to mask the whole-word sequences of the optimal local alignment to generate word-masked strings; using the word-masked strings, to repeat the arranging, determining, and masking steps a number of times to generate a number of match scores; to combine the number of match scores into a combined score that represents similarities between the pair of strings, wherein the combined score is insensitive to translocation and word truncations; and to determine alignment between the pair of strings based on the combined score.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 is a block diagram of a string-matching environment in accordance with an illustrative embodiment;

FIG. 3 is an illustration of a similarity matrix depicted in accordance with an illustrative embodiment

FIG. 4 is a flowchart of a process for determining string alignment with insensitivity to translocation depicted in accordance with an illustrative embodiment;

FIG. 5 is a flowchart of a first process for determining a match score for an optimal local alignment depicted in accordance with an illustrative embodiment;

FIG. 6 is a flowchart of a second process for determining a match score for an optimal local alignment depicted in accordance with an illustrative embodiment;

FIG. 7A-7D is an illustration of pseudocode for a determining string alignment with insensitivity to translocation depicted in accordance with an illustrative embodiment; and

FIG. 8 is a block diagram of a data processing system in accordance with an illustrative embodiment.

### DETAILED DESCRIPTION

The illustrative embodiments recognize and take into account one or more different considerations. For example, the illustrative embodiments recognize and take into account that known natural language processing algorithms do not perform as well as desired when applied to terse, jargon-laden, content such as customs transaction records.

Thus, the illustrative embodiments recognize and take into account that it would be desirable to have a method, apparatus, computer system, and computer program product that take into account the issues discussed above as well as other possible issues. For example, it would be desirable to have a method, apparatus, computer system, and computer program product that provide algorithms for determining string alignment with insensitivity to whole-word truncations and translocations.

In one illustrative example, a computer system is provided for determining string alignment with insensitivity to translocation. The computer system comprises a hardware processor, and a string alignment engine indication with the hardware processor. The string alignment engine is configured: to arrange a pair of strings in a similarity matrix; to determine a match score for an optimal local alignment of whole-word sequences between the pair of strings; to mask the whole-word sequences of the optimal local alignment to generate word-masked strings; using the word-masked strings, to repeat the arranging, determining, and masking steps a number of times to generate a number of match scores; to combine the number of match scores into a combined score that represents similarities between the pair of strings, wherein the combined score is insensitive to translocation and word truncations; and to determine alignment between the pair of strings based on the combined score.

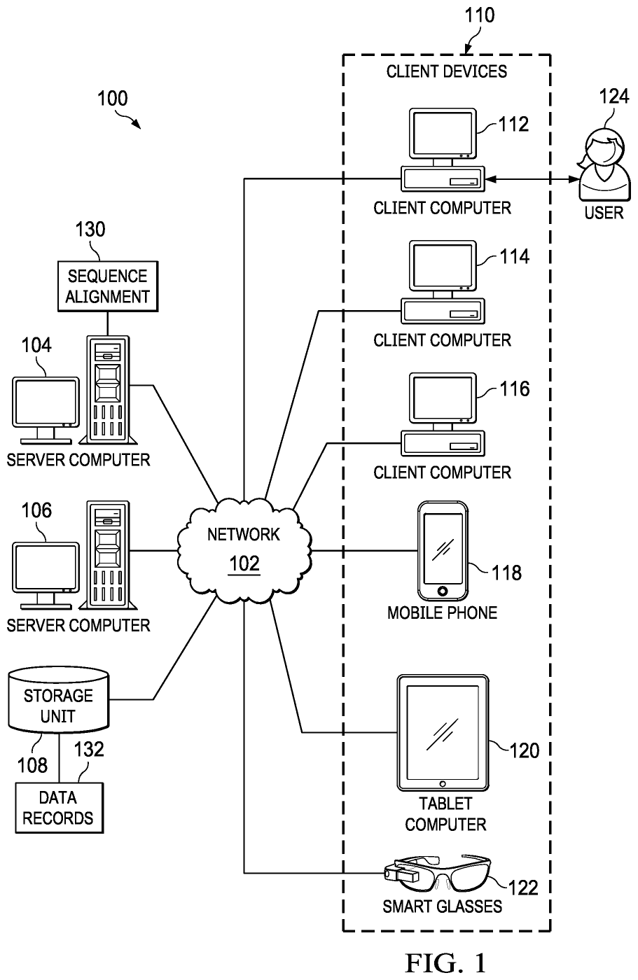

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. As depicted, client devices 110 include client computer 112, client computer 114, and client computer 116. Client devices 110 can be, for example, computers, workstations, or network computers. In the depicted example, server computer 104 provides information, such as boot files, operating system images, and applications to client devices 110. Further, client devices 110 can also include other types of client devices such as mobile phone 118, tablet computer 120, and smart glasses 122. In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage media and downloaded to a data processing system or other device for use. For example, the program code can be stored on a computer-recordable storage media on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

As used herein, a “number of,” when used with reference to items, means one or more items. For example, a “number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

In the illustrative example, user 124 operates client computer 112. In the illustrative example, sequence alignment 130 can determine string alignment between data records 132. For example, sequence alignment 130 may determine string alignment in response to receiving a search request from user 124.

In this illustrative example, sequence alignment 130 can run on client computer 114 and can take the form of a system instance of the application. In another illustrative example, sequence alignment 130 can be run in a remote location such as on server computer 104. In yet other illustrative examples, sequence alignment 130 can be distributed in multiple locations within network data processing system 100. For example, sequence alignment 130 can run on client computer 112 and on client computer 114 or on client computer 112 and server computer 104 depending on the particular implementation.

Sequence alignment 130 can operate to determining string alignment for matching data records. Sequence alignment 130 provides method with specific properties that are particularly applicable to analysis of free-form phrase-like text content, such as found in portions of these customs records.
Sequence alignment 130 is insensitive to translocations. For example, sequence alignment 130 will consider “Fruit Computers” to be similar to “Computers Fruit”.
Sequence alignment 130 is insensitive to whole-word truncations. For example, sequence alignment 130 will consider “Fruit Computers” to be similar to “Fruit” or “Computers”.
Sequence alignment 130 is sensitive to “abbreviation truncations. For example, sequence alignment 130 will consider “Fruit Computers” to be dissimilar from “Fr Computers”.

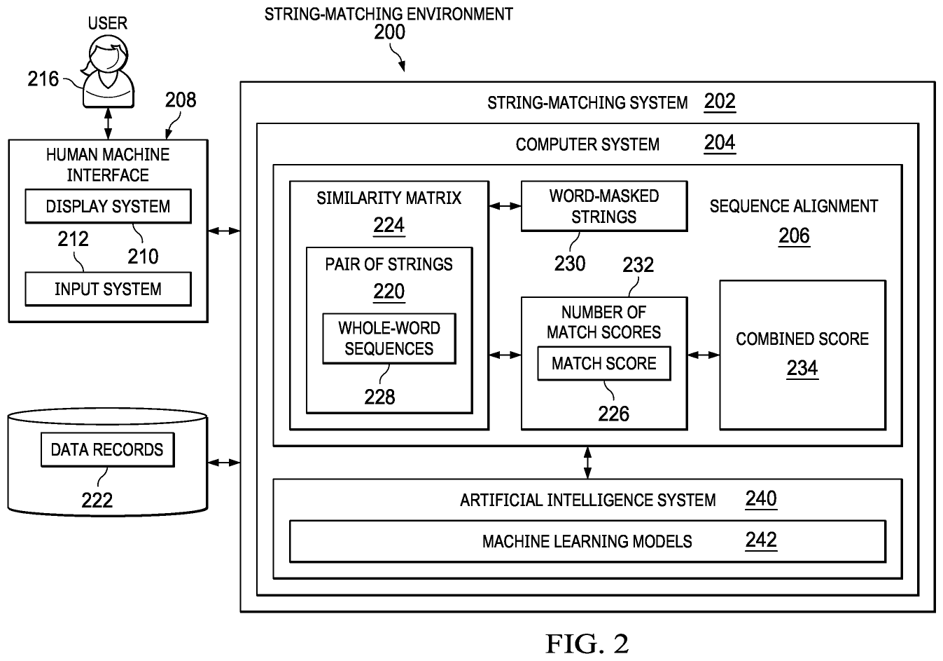

With reference now to FIG. 2, a block diagram of a string-matching environment is depicted in accordance with an illustrative embodiment. In this illustrative example, string matching environment 200 includes components that can be implemented in hardware such as the hardware shown in network data processing system 100 in FIG. 1.

As depicted, string matching system 202 comprises computer system 204 and sequence alignment 206. Sequence alignment 206 runs in computer system 204. Sequence alignment 206 is an example of one embodiment of sequence alignment 130 of FIG. 1. Sequence alignment 206 can be implemented in software, hardware, firmware, or a combination thereof. When software is used, the operations performed by sequence alignment 206 can be implemented in program code configured to run on hardware, such as a processor unit. When firmware is used, the operations performed by sequence alignment 206 can be implemented in program code and data and stored in persistent memory to run on a processor unit. When hardware is employed, the hardware may include circuits that operate to perform the operations in sequence alignment 206.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, human machine interface 208 comprises display system 210 and input system 212. Display system 210 is a physical hardware system and includes one or more display devices on which graphical user interface 214 can be displayed. The display devices can include at least one of a light emitting diode (LED) display, a liquid crystal display (LCD), an organic light emitting diode (OLED) display, a computer monitor, a projector, a flat panel display, a heads-up display (HUD), or some other suitable device that can output information for the visual presentation of information.

User 216 is a person that can interact with graphical user interface 214 through user input generated by input system 212 for computer system 204. Input system 212 is a physical hardware system and can be selected from at least one of a mouse, a keyboard, a trackball, a touchscreen, a stylus, a motion sensing input device, a gesture detection device, a cyber glove, or some other suitable type of input device.

In this illustrative example, human machine interface 208 can enable user 216 to interact with one or more computers or other types of computing devices in computer system 204. For example, these computing devices can be client devices such as client devices 110 in FIG. 1.

In this illustrative example, sequence alignment 206 in computer system 204 is configured to determine alignment between pair of strings 220 with insensitivity to word translocations. In one or more illustrative examples, sequence alignment 206 determines alignment in a manner that reduces mismatches with data records 222 due to translocation errors between pair of strings 220. In one or more illustrative examples, sequence alignment 206 determines alignment in a manner that reduces mismatches with data records 222 due to truncation errors between pair of strings 220.

In one illustrative example, sequence alignment 206 is implemented as a dynamic programming algorithm designed to interoperate with numerical libraries, such as NumPy. NumPy is a library for the Python programming language, adding support for large, multi-dimensional arrays and matrices, along with a large collection of high-level mathematical functions to operate on these arrays.

Dynamic programming (also known as dynamic optimization) is a method for solving a complex problem by breaking it down into a collection of simpler sub-problems. A dynamic programming algorithm examines the previously solved sub-problems and then combines their solutions to give the best solution for the given problem. Dynamic programming algorithm for performing alignment functions include the Needleman-Wunsch algorithm and Smith-Waterman algorithm.

Sequence alignment 206 arranges a pair of strings 220 in a similarity matrix 224. The size of the matrix is the length of one sequence plus 1 by the length of the other sequence plus 1. The additional first row and first column serve the purpose of aligning one sequence to any positions in the other sequence. Both the first row and the first column are set to 0 so that end gap is not penalized.

Similarity matrix 224 records the optimal alignment results of one-to-one comparisons between all elements in pair of strings 220. The final optimal alignment is found by iteratively expanding the growing optimal alignment of the individual elements. In other words, the current optimal alignment is generated by deciding which path (match/mismatch or inserting gap) gives the highest score from the previous optimal alignment.

Sequence alignment 206 determining a match score 226 for an optimal local alignment of whole-word sequences 228 between the pair of strings 220. Sequence alignment 206 scores each element from left to right, top to bottom in similarity matrix 224, considering the outcomes of substitutions (diagonal scores) or adding gaps (horizontal and vertical scores). Sequence alignment 206 then performs a traceback from the largest magnitude score based on the source of each score recursively, until 0 score is encountered. The segments that have the highest similarity score based on the given scoring system is the optimal local alignment of whole-word sequences 228.

In one illustrative example, sequence alignment 206 prevents match boundaries in the middle of words for one string in the pair of strings when determining a match score for an optimal local alignment of whole word sequences between the pair of strings. Unlike other dynamic programming algorithms that identify string boundaries by simply search the matrix for the largest score, sequence alignment 206 only looks at spots in pair of strings 220 that are associated with a space or the end of the string for determining string boundaries.

For example, sequence alignment 206 may identify spaces or other characters indicating the end of a word in the string. Sequence alignment 206 may then substitute the score for that element with an arbitrarily large number. This number is large enough that it is otherwise unattainable through normal scoring with the algorithm. The substitution ensures the desired edge conditions for the optimal local alignment that allow for word truncation. In other words, sequence alignment 206 sets the match boundaries set at the space or the end of the string.

For example, given the two strings “main street” “main stage”, prior dynamic programming algorithms, such as Smith-Waterman, would match “main st” with both words. However, in the context the present invention, this alignment may not be desirable. Sequence alignment 206 would only match “main”, with “street” and “stage” and not close enough to align. As another Example, given the two strings “george washington” and “a washed plate”, sequence alignment 206 may set the match boundaries to prevent optimal local alignment on “wash”. Combining the number of match scores in this manner allows sequence alignment 206 to represents similarities between the pair of strings in a manner that is sensitive to word truncations.

In an alternative embodiment, sequence alignment 206 may set one or more of match values and gap costs to a value that prevents match boundaries in the middle of words in the pair of strings.

In one illustrative example, sequence alignment 206 normalizes match score 226 against the larger string of pair of strings 220. Normalization ensures that empty/short strings don't always score very high when determining the match score for an optimal local alignment.

Sequence alignment 206 applies multiple iterations of string alignment so as to line up strings with translocations. Sequence alignment 206 masks the whole word sequences of the optimal local alignment to generate word-masked strings 230. Then, using the word-masked strings 230, sequence alignment 206 repeating the arranging, determining, and masking steps a number of times to generate a number of match scores 232.

For example, given two strings “Fruit Computers”, “Computers Fruit”, prior dynamic programming algorithms will just match the word “Computers” and leave the remainder unmatched. However, by applying multiple alignment iterations, sequence alignment 206 will start off by matching “Computers”. Sequence alignment 206 will then censor out the matched portion from the prior iteration, and run the algorithm again, this time matching on the word “Fruit”. Sequence alignment 206 then combines the scores of these two matched regions to generate combined score 234. The only unmatched character will be the space. Sequence alignment 206 combines the number of match scores 232 to generate combined score 234. Combining number of match scores 232 in this manner allows sequence alignment 206 to represents similarities between the pair of strings 220 in a manner that is insensitive to translocation. Sequence alignment 206 then determines string alignment based on the combined score 234.

In some illustrative examples, sequence alignment 206 can be used by artificial intelligence system 240. Artificial intelligence system 240 is a system that has intelligent behavior and can be based on the function of a human brain. An artificial intelligence system comprises at least one of an artificial neural network, a cognitive system, a Bayesian network, a fuzzy logic, an expert system, a natural language system, or some other suitable system. Sequence alignment 206 can be used in one or more layers or nodes of artificial intelligence system 240.

Machine learning is used to train the artificial intelligence system. Machine learning involves inputting data to the process and allowing the process to adjust and improve the function of the artificial intelligence system.

In this illustrative example, artificial intelligence system 240 can include a set of machine learning models 242. A machine learning model is a type of artificial intelligence model that can learn without being explicitly programmed. A machine learning model can learn based on training data input into the machine learning model. The machine learning model can learn using various types of machine learning algorithms. The machine learning algorithms include at least one of a supervised learning, an unsupervised learning, a feature learning, a sparse dictionary learning, and anomaly detection, association rules, or other types of learning algorithms. Examples of machine learning models include an artificial neural network, a decision tree, a support vector machine, a Bayesian network, a genetic algorithm, and other types of models. These machine learning models can be trained using data and process additional data to provide a desired output. The algorithms of sequence alignment 206 can be employed as machine learning algorithms in one or more of set of machine learning models 242.

In one illustrative example, one or more solutions are present that overcome a problem with the application of natural language processing algorithms to non-natural language content, such as the terse, jargon-laden, multiple-language content that characterizes customs transaction records. As a result, one or more illustrative examples provide algorithms for determining string alignment with insensitivity to translocation, and sensitivity to truncation. These algorithms can be applied in an artificial intelligence system that may result in improved performance in interpretation of data records.

Computer system 204 can be configured to perform at least one of the steps, operations, or actions described in the different illustrative examples using software, hardware, firmware, or a combination thereof. As a result, computer system 204 operates as a special purpose computer system in sequence alignment 206 in computer system 204. In particular, sequence alignment 206 transforms computer system 204 into a special purpose computer system as compared to currently available general computer systems that do not have sequence alignment 206. In this example, computer system 204 operates as a tool that can increase at least one of speed, accuracy, or usability of computer system 204. In particular, this increase in performance of computer system 204 can be for the use of artificial intelligence system 240. In one illustrative example, sequence alignment 206 provides for increased accuracy, comprehension and forecasting by artificial intelligence system 240 as compared with using current documentation systems.

The illustration of string-matching environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

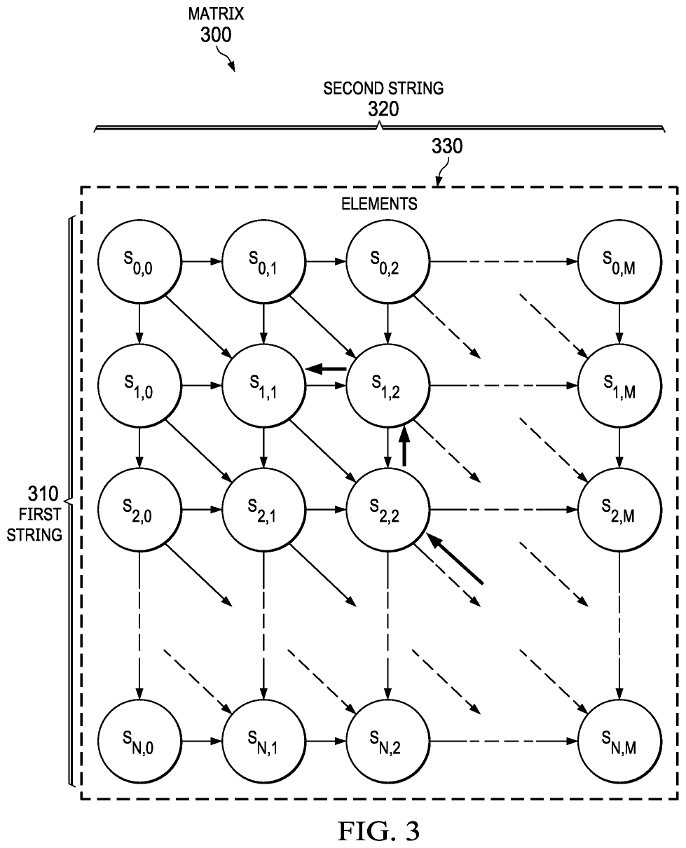

Turning now to FIGS. 3, an illustration of a similarity matrix is depicted in accordance with an illustrative embodiment. Similarity matrix 300 is an example one implementation for similarity matrix 224 in FIG. 2.

First string 310, whose length is denoted N, corresponds to the vertical axis of similarity matrix 300. Second string 320, whose length is denoted M, corresponds to the horizontal axis of similarity matrix 300. Together, first string 310 and second string 320 comprise a pair of strings, such as pair of strings 220 of FIG. 2.

Similarity matrix 300 is an N-by-M matrix. Similarity matrix 300 comprises elements 330, wherein each element denoted S_{i,j} represents the distance between the i^{th} data element of first string 310 and the j^{th} data element of second string 320.

The dimensions of similarity matrix 300 are 1+length of first string 310 and second string 320, respectively. All the elements of the first row and the first column are set to 0. The extra first row and first column make it possible to align one sequence to another at any position, and setting them to 0 makes any terminal gap free from penalty.

The function of similarity matrix 300 is to conduct one-to-one comparisons between all components in two sequences and record the optimal alignment results. Similarity matrix 300 assigns string characters a score for match or mismatch. The final optimal alignment is found by iteratively expanding the growing optimal alignment. In other words, the current optimal alignment is generated by deciding which path (match/mismatch or inserting gap) gives the highest score from the previous optimal alignment.

Each element 330 in similarity matrix 300 is scored from left to right, top to bottom, considering the outcomes of substitutions or adding gaps. The highest magnitude score is used, and the source of that score is recorded.

In the illustrative examples, it may be desirable that |mismatch|>|match|. This mismatch scoring preference is important for some edge cases of the algorithm, as it prevents “A B C D” from matching “X Y Z D.”.

To find the optimal local alignment, a traceback procedure starts at the element with the highest score, back tracing though elements 330 based on the source of each score recursively, until 0 is encountered. The segments that have the highest similarity score based on the given scoring system is generated in this process.

Algorithms of the illustrative embodiments modify the traceback procedure of other dynamic programming algorithms. Rather than searching the matrix for the largest score, the illustrative embodiments only look at spots that are associated with a space or the end of the string.

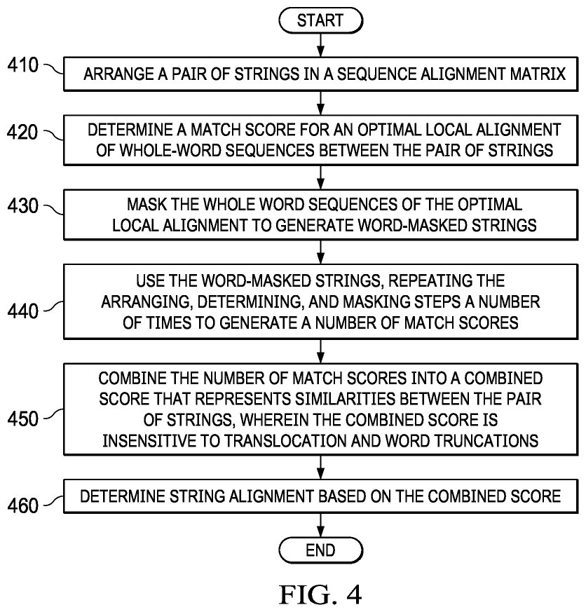

Turning next to FIG. 4, a flowchart of a process for determining string alignment with insensitivity to translocation is depicted in accordance with an illustrative embodiment. The process in FIG. 4 can be implemented in hardware, software, or both. When implemented in software, the process can take the form of program code that is run by one or more processor units located in one or more hardware devices in one or more computer systems. For example, the process can be implemented in sequence alignment 206 in computer system 204 in FIG. 2.

The process begins by arranging a pair of strings in a similarity matrix (step 410). The similarity matrix can be, for example, similarity matrix 224 of FIG. 2.

The process determines a match score for an optimal local alignment of whole-word sequences between the pair of strings (step 420). For example, each element in the similarity matrix may be scored, considering the outcomes of substitutions, or adding gaps, with a recursive traceback from the largest magnitude score.

The process masks the whole word sequences of the optimal local alignment to generate word-masked strings (step 430). Using the word-masked strings, the process repeats the arranging, determining, and masking steps a number of times to generate a number of match scores (step 440).

The process combines the number of match scores into a combined score that represents similarities between the pair of strings, wherein the combined score is insensitive to translocation and word truncations (step 450). The process determines string alignment based on the combined score (step 460), such that the final string alignment is insensitive to translocation and word truncations. The process terminates thereafter.

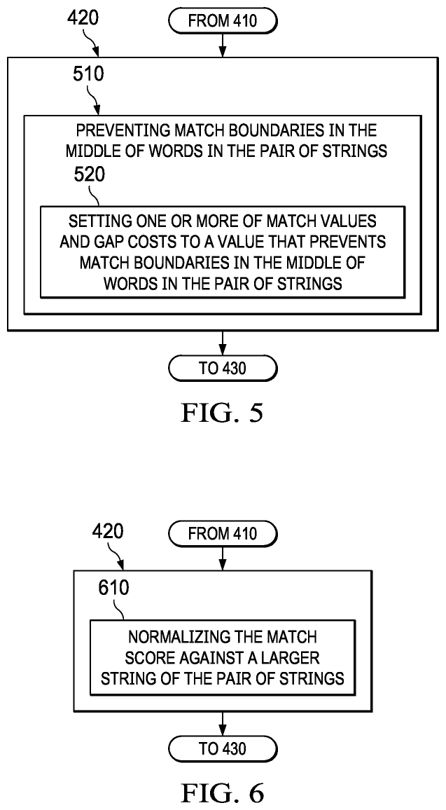

Turning next to FIG. 5, a flowchart of a process for determining a match score for an optimal local alignment is depicted in accordance with an illustrative embodiment. The process in FIG. 5 is one example of process step 420 of FIG. 4.

Continuing from step 410 of FIG. 4, the process determines a match score for an optimal local alignment of whole-word sequences between the pair of strings. In this illustrative example, determining the match score includes preventing match boundaries in the middle of words in the pair of strings (step 510). In one illustrative example, preventing match boundaries includes setting one or more of match values and gap costs to a value that prevents match boundaries in the middle of words in the pair of strings (step 520). Thereafter, the process can continue to step 430 of FIG. 4.

Turning next to FIG. 6, a flowchart of a process for determining a match score for an optimal local alignment is depicted in accordance with an illustrative embodiment. The process in FIG. 6 is one example of process step 420 of FIG. 4.

Continuing from step 410 of FIG. 4, the process determines a match score for an optimal local alignment of whole-word sequences between the pair of strings. In this illustrative example, determining the match score includes normalizing the match score against a larger string of the pair of strings (step 610). Thereafter, the process can continue to step 430 of FIG. 4.

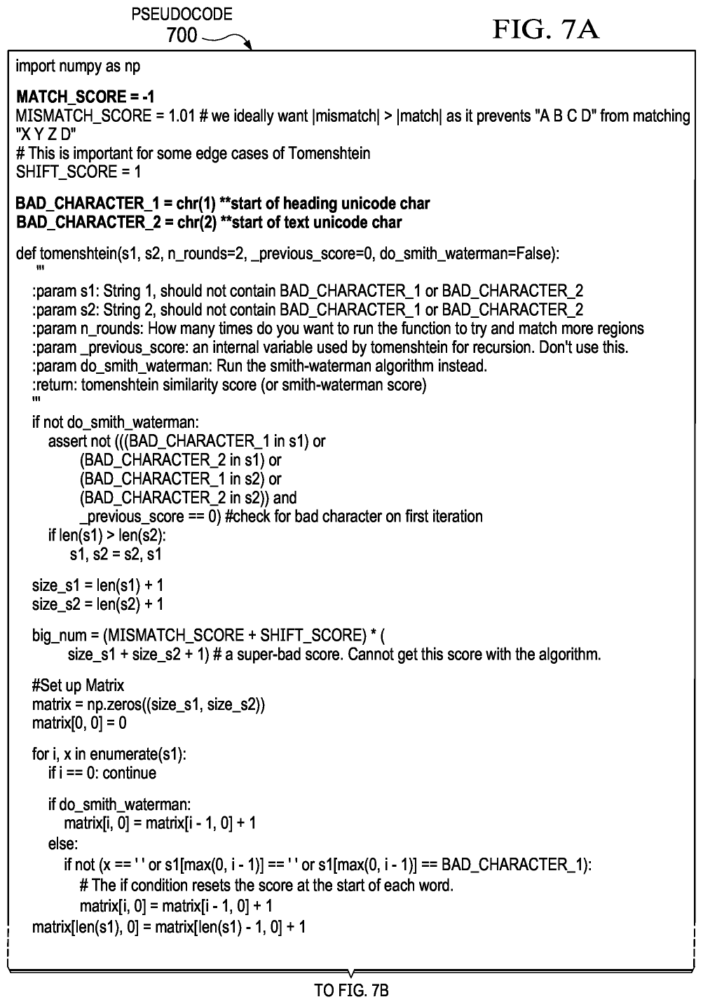

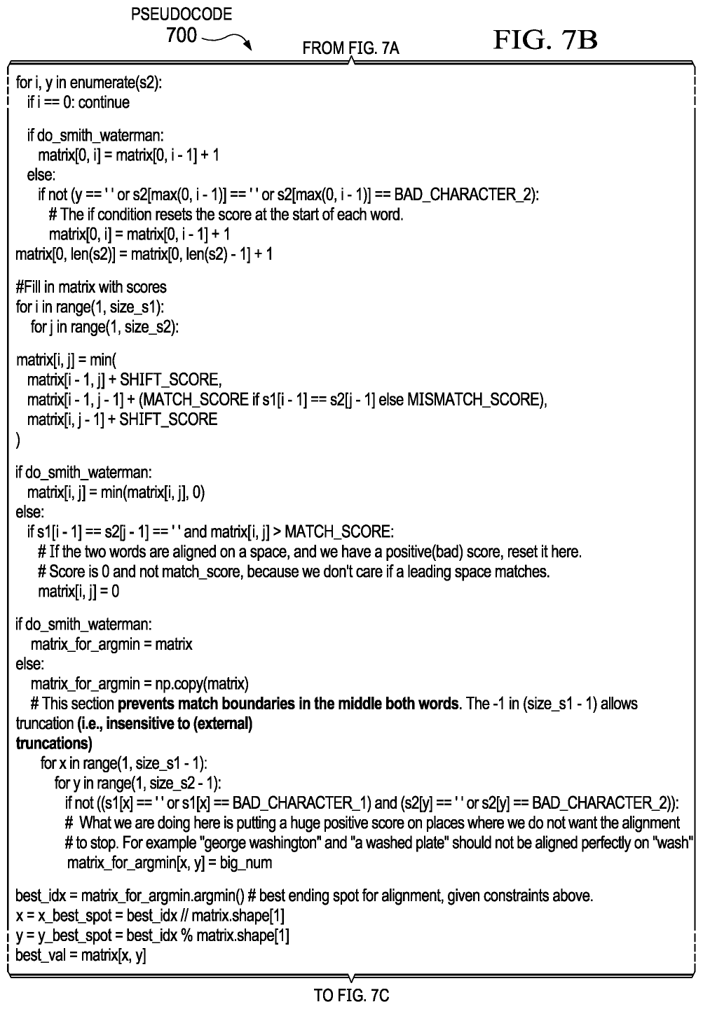

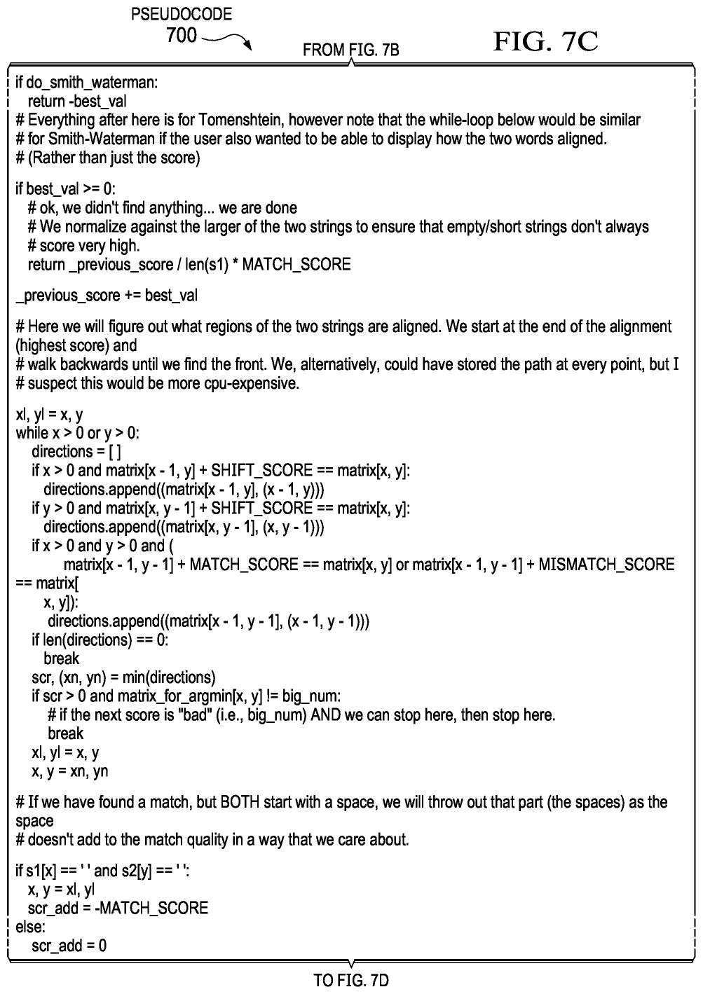

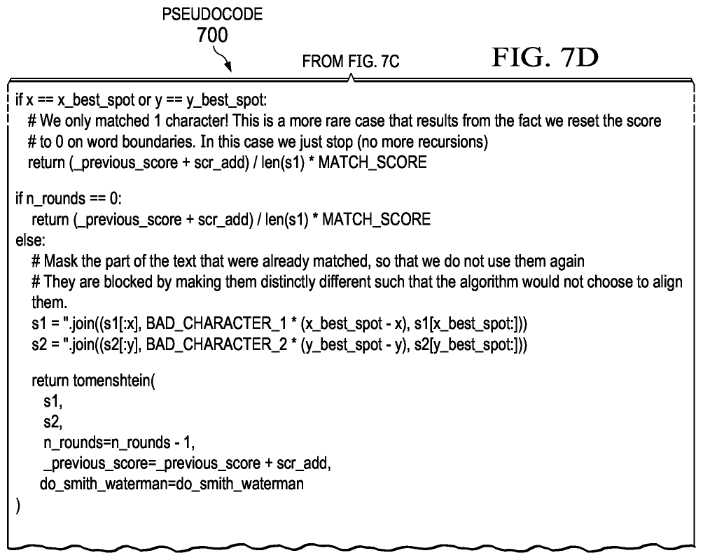

With reference next to FIG. 7A-7D, an illustration of pseudocode for a determining string alignment with insensitivity to translocation is depicted in accordance with an illustrative embodiment. In this illustrative example, pseudocode 700 may be implemented in sequence alignment 206, as shown in block form in FIG. 2.

Pseudocode 700 is an example of code for a process to determine string alignment with insensitivity to translocation, and may be used to implement process 400 in FIG. 4. When executed by a processor, pseudocode 700: arranges a pair of strings in a similarity matrix; determines a match score for an optimal local alignment of whole-word sequences between the pair of strings; masks the whole-word sequences of the optimal local alignment to generate word-masked strings; using the word-masked strings, repeats the arranging, determining, and masking steps a number of times to generate a number of match scores; combines the number of match scores into a combined score that represents similarities between the pair of strings, wherein the combined score is insensitive to translocation and word truncations; and determines alignment between the pair of strings based on the combined score.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams can be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

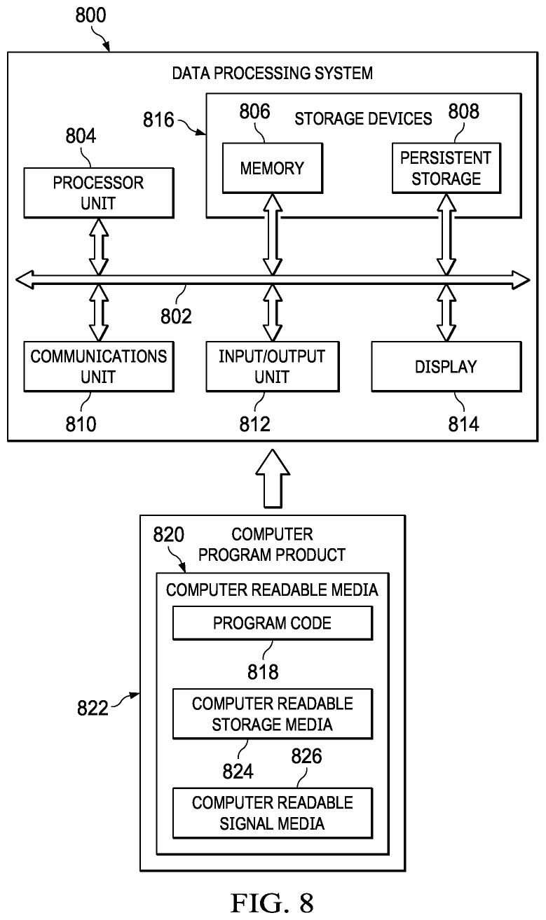

Turning now to FIG. 8, a block diagram of a data processing system is depicted in accordance with an illustrative embodiment. Data processing system 800 can be used to implement server computer 104, server computer 106, client devices 110, in FIG. 1. Data processing system 800 can also be used to implement computer system 204 in FIG. 2. In this illustrative example, data processing system 800 includes communications framework 802, which provides communications between processor unit 804, memory 806, persistent storage 808, communications unit 810, input/output (I/O) unit 812, and display 814. In this example, communications framework 802 takes the form of a bus system.

Processor unit 804 serves to execute instructions for software that can be loaded into memory 806. Processor unit 804 includes one or more processors. For example, processor unit 804 can be selected from at least one of a multicore processor, a central processing unit (CPU), a graphics processing unit (GPU), a physics processing unit (PPU), a digital signal processor (DSP), a network processor, or some other suitable type of processor. Further, processor unit 804 can may be implemented using one or more heterogeneous processor systems in which a main processor is present with secondary processors on a single chip. As another illustrative example, processor unit 804 can be a symmetric multi-processor system containing multiple processors of the same type on a single chip.

Memory 806 and persistent storage 808 are examples of storage devices 816. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 816 may also be referred to as computer-readable storage devices in these illustrative examples. Memory 806, in these examples, can be, for example, a random-access memory or any other suitable volatile or non-volatile storage device. Persistent storage 808 may take various forms, depending on the particular implementation.

For example, persistent storage 808 may contain one or more components or devices. For example, persistent storage 808 can be a hard drive, a solid-state drive (SSD), a flash memory, a rewritable optical disk, a rewritable magnetic tape, or some combination of the above. The media used by persistent storage 808 also can be removable. For example, a removable hard drive can be used for persistent storage 808.

Communications unit 810, in these illustrative examples, provides for communications with other data processing systems or devices. In these illustrative examples, communications unit 810 is a network interface card.

Input/output unit 812 allows for input and output of data with other devices that can be connected to data processing system 800. For example, input/output unit 812 may provide a connection for user input through at least one of a keyboard, a mouse, or some other suitable input device. Further, input/output unit 812 may send output to a printer. Display 814 provides a mechanism to display information to a user.

Instructions for at least one of the operating system, applications, or programs can be located in storage devices 816, which are in communication with processor unit 804 through communications framework 802. The processes of the different embodiments can be performed by processor unit 804 using computer-implemented instructions, which may be located in a memory, such as memory 806.

These instructions are program instructions and are also referred are referred to as program code, computer usable program code, or computer-readable program code that can be read and executed by a processor in processor unit 804. The program code in the different embodiments can be embodied on different physical or computer-readable storage media, such as memory 806 or persistent storage 808.

Program code 818 is located in a functional form on computer-readable media 820 that is selectively removable and can be loaded onto or transferred to data processing system 800 for execution by processor unit 804. Program code 818 and computer-readable media 820 form computer program product 822 in these illustrative examples. In the illustrative example, computer-readable media 820 is computer-readable storage media 824.

In these illustrative examples, computer-readable storage media 824 is a physical or tangible storage device used to store program code 818 rather than a medium that propagates or transmits program code 818. Computer-readable storage media 824, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. The term “non-transitory” or “tangible”, as used herein, is a limitation of the medium itself (i.e., tangible, not a signal) as opposed to a limitation on data storage persistency (e.g., RAM vs. ROM).

Alternatively, program code 818 can be transferred to data processing system 800 using a computer-readable signal media. The computer-readable signal media are signals and can be, for example, a propagated data signal containing program code 818. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media” can be singular or plural. For example, program code 818 can be located in computer-readable media 820 in the form of a single storage device or system. In another example, program code 818 can be located in computer-readable media 820 that is distributed in multiple data processing systems. In other words, some instructions in program code 818 can be located in one data processing system while other instructions in program code 818 can be located in one data processing system. For example, a portion of program code 818 can be located in computer-readable media 820 in a server computer while another portion of program code 818 can be located in computer-readable media 820 located in a set of client computers.

The different components illustrated for data processing system 800 are not meant to provide architectural limitations to the manner in which different embodiments can be implemented. In some illustrative examples, one or more of the components may be incorporated in or otherwise form a portion of, another component. For example, memory 806, or portions thereof, may be incorporated in processor unit 804 in some illustrative examples. The different illustrative embodiments can be implemented in a data processing system including components in addition to or in place of those illustrated for data processing system 800. Other components shown in FIG. 8 can be varied from the illustrative examples shown. The different embodiments can be implemented using any hardware device or system capable of running program code 818.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer-implemented method for determining string alignment with insensitivity to translocation, the method comprising:
arranging a pair of strings in a similarity matrix;
determining a match score for an optimal local alignment of whole-word sequences between the pair of strings;
masking the whole-word sequences of the optimal local alignment to generate word-masked strings;
using the word-masked strings, repeating the arranging, determining, and masking steps a number of times to generate a number of match scores;
combining the number of match scores into a combined score that represents similarities between the pair of strings, wherein the combined score is insensitive to translocation and word truncations; and
determining alignment between the pair of strings based on the combined score.

2. The method of claim 1, wherein the combined score is sensitive to word truncations.

3. The method of claim 2, wherein determining a match score for an optimal local alignment of whole word sequences between the pair of strings further comprises:
preventing match boundaries in the middle of words in the pair of strings.

4. The method of claim 3, wherein preventing match boundaries in the middle of words further comprises:
setting one or more of match values and gap costs to a value that prevents match boundaries in the middle of words in the pair of strings.

5. The method of claim 1, wherein determining a match score for an optimal local alignment of whole word sequences between the pair of strings further comprises:
normalizing the match score against a larger string of the pair of strings.

6. The method of claim 1, wherein mismatches due to translocation errors are reduced.

7. The method of claim 1, wherein mismatches due to truncation errors are reduced.

8. A computer system comprising:
a hardware processor; and
a sequence alignment, in communication with the hardware processor, wherein the sequence alignment is configured:
to arrange a pair of strings in a similarity matrix;
to determine a match score for an optimal local alignment of whole-word sequences between the pair of strings;
to mask the whole-word sequences of the optimal local alignment to generate word-masked strings;
using the word-masked strings, to repeat the arranging, determining, and masking steps a number of times to generate a number of match scores;
to combine the number of match scores into a combined score that represents similarities between the pair of strings, wherein the combined score is insensitive to translocation and word truncations; and
to determine alignment between the pair of strings based on the combined score.

9. The computer system of claim 8, wherein the combined score is sensitive to word truncations.

10. The computer system of claim 9, wherein in determining a match score for an optimal local alignment of whole word sequences between the pair of strings, the sequence alignment is further configured:
to prevent match boundaries in the middle of words in the pair of strings.

11. The computer system of claim 10, wherein in preventing match boundaries in the middle of words, the sequence alignment is further configured:
setting one or more of match values and gap costs to a value that prevents match boundaries in the middle of words in the pair of strings.

12. The computer system of claim 8, wherein in determining a match score for an optimal local alignment of whole word sequences between the pair of strings, the sequence alignment is further configured:
normalizing the match score against a larger string of the pair of strings.

13. The computer system of claim 8, wherein mismatches due to translocation errors are reduced.

14. The computer system of claim 8, wherein mismatches due to truncation errors are reduced.

15. A computer program product comprising:
a computer readable storage media; and
program code, stored on the computer readable storage media, for determining string alignment with insensitivity to translocation, the program code comprising:
code for arranging a pair of strings in a similarity matrix;
code for determining a match score for an optimal local alignment of whole-word sequences between the pair of strings;
code for masking the whole-word sequences of the optimal local alignment to generate word-masked strings;
code for repeating, using the word-masked strings, the arranging, determining, and masking steps a number of times to generate a number of match scores;
code for combining the number of match scores into a combined score that represents similarities between the pair of strings, wherein the combined score is insensitive to translocation and word truncations; and
code for determining alignment between the pair of strings based on the combined score.

16. The computer program product of claim 15, wherein the combined score is sensitive to word truncations.

17. The computer program product of claim 16, wherein determining a match score for an optimal local alignment of whole word sequences between the pair of strings further comprises:
preventing match boundaries in the middle of words in the pair of strings.

18. The computer program product of claim 17, wherein preventing match boundaries in the middle of words further comprises:
setting one or more of match values and gap costs to a value that prevents match boundaries in the middle of words in the pair of strings.

19. The computer program product of claim 15, wherein determining a match score for an optimal local alignment of whole word sequences between the pair of strings further comprises:
normalizing the match score against a larger string of the pair of strings.

20. The computer program product of claim 15, wherein mismatches due to translocation errors are reduced.

21. The computer program product of claim 15, wherein mismatches due to truncation errors are reduced.
